(19) United States
(12) Patent Application Publication
(10) Pub. No.: US 2016/0017914 A1
(43) Pub. Date: Jan. 21, 2016

(54) METHOD OF SETTING BEARING PRELOAD

(71) Applicant: AKTIEBOLAGET SKF, Göteborg (SE)

(72) Inventors: Cornelius Petrus Antonius VISSERS, Den Dungen (NL); Alessandro GARRONE, Utrecht (NL); Alessandro FORNERO, Utrecht (NL); Padelis KATSAROS, Schweinfurt (DE); Isidoro Francesco MAZZITELLI, Nieuwegein (NL)

(73) Assignee: AKTIEBOLAGET SKF, Göteborg (SE)

(21) Appl. No.: 14/771,386

(22) PCT Filed: Mar. 6, 2013
(86) PCT No.: PCT/EP2013/054475

§ 371 Date: Aug. 28, 2015

(51) Int. Cl. F16C 25/06; F16C 19/36; F16C 19/56

(52) U.S. Cl. CPC F16C 25/06; F16C 19/56; F16C 19/364

(57) ABSTRACT

A method of setting a desired axial preload F_{P} in a bearing arrangement by selecting a shim that will generate the desired preload at a predetermined axial force F_{A} applied by a clamping element, such as a locknut. The method comprises steps of: (a) mounting a reference shim, having a known thickness t, and preloading the bearing arrangement using the shim, by applying the predetermined axial force F_{A}; (b) measuring the actual preload of the bearing arrangement F_{actual}; and (c) constructing an analytical model that defines a correlation between bearing preload and applied axial force on the bearing arrangement, for a plurality of different shims, whereby each shim in the plurality of shims is defined in terms of an initial axial gap δ between the shim and an axially displaceable bearing ring of the bearing arrangement, and in terms of a certain clamping force at which the gap becomes zero.

### CROSS REFERENCE TO RELATED APPLICATION

This is a United States National Stage application claiming the benefit of International Application Number PCT/EP2013/054475 filed on 6 Mar. 2013 (Jun. 3, 2013), which is incorporated herein by reference in its entirety.”

### FIELD OF THE INVENTION

The present invention relates to a method of setting a desired axial preload in a bearing arrangement by selecting an appropriate shim.

### BACKGROUND TO THE INVENTION

Bearing preload is a force acting between the rolling elements and bearing rings that is not caused by external load. Preload can also be regarded as negative internal clearance, and may be applied to increase stiffness, enhance running accuracy, reduce noise level and improve service life. In bearing types which are designed for transmitting both axial and radial loads, such as taper roller bearings, an axial preload is applied. Sufficient preload is important for ensuring that the loads are evenly distributed amongst the rollers. On the other hand, excessive preload will cause friction and wear, which shortens bearing life.

A common method of setting axial preload in e.g. a double-row taper roller bearing arrangement is to use spacing elements or shims. One or more shims of specific thickness are used to set the desired preload, but due to manufacturing tolerances of the bearing, the shaft and the housing, a shim of the same thickness does not always generate the same preload in the same bearing arrangement. The shim sets a specific gap over which one of the bearing rings is axially displaced relative to the other, but the magnitude of this gap is not known with precision. Therefore, preload is often measured after the bearing arrangement has been assembled and, if necessary, a shim of different thickness is used.

In U.S. Pat. No. 5,115,558, an apparatus is disclosed for determining shim thicknesses used to position bearings on shafts located in recesses formed in a casing. An apparatus plate of predetermined thickness is located between the flanges of two casing halves. An axial force measuring cell is fitted on the bearing and the two casing halves are clamped together with a predetermined load. Axial forces produced by the clamping action of the casing on the shafts are measured during operation and correlated with a predetermined, desired axial force by a computer. The optimum thickness of the shims for the individual shafts is calculated from data supplied to the computer.

There is still room for improvement.

### SUMMARY OF THE INVENTION

The present invention resides in a method of setting a desired axial preload FP in a bearing arrangement having an inner ring and an outer ring, whereby one of the bearing rings is axially displaceable relative to the other of the bearing rings.

Specifically, the method of the invention is based on selecting a shim that will generate the desired preload at a predetermined axial force applied by a clamping element, such as a locknut. The method comprises steps of:
(a) mounting a reference shim, which has a known thickness t, and preloading the bearing arrangement using the shim, by applying a predetermined axial force F_{A};
(b) measuring the actual preload of the bearing arrangement F_{actual}; and
(c) constructing an analytical model that defines a correlation between bearing preload and applied axial force on the bearing arrangement, when the arrangement comprises a plurality of different shims. Each shim in the plurality of shims is defined in terms of an initial axial gap δ₁, δ₂, δ₃, . . . δᵢ between the shim and an axially displaceable bearing ring of the bearing arrangement, and in terms of a certain clamping force F_{c1}, F_{c2}, F_{c3}, . . . F_{ci at} which the gap becomes zero.

The analytical model can therefore be used to identify the reference shim as the shim from the plurality of shims that generates the measured preload F_{actual} at the predetermined axial force F_{A}. Consequently, an initial axial gap δ_{f} generated by the reference shim is known. The analytical model is further used to identify a target shim from the plurality of shims that would generate the desired preload F_{P} at the predetermined axial force F_{A}. An initial axial gap generated by the target shim δ_{target} is therefore also known.

The desired axial preload F_{P} is set by replacing the reference shim with a shim that has a thickness of t+(δ_{target}−δ_{ref}) and applying the predetermined axial force F_{A} on the bearing arrangement.

Any known method of measuring bearing preload may be used to determine F_{actual}. In a preferred embodiment of the invention, the step of measuring preload comprises measuring a value σ_{actual} of a parameter that is representative of the stiffness of the bearing arrangement. As known to the skilled person, a direct relationship exists between bearing preload and bearing stiffness. Suitably, the analytical model then defines a correlation between the measured parameter and bearing preload and further defines a correlation between the measured parameter and applied axial force for the plurality of shims. The analytical model is thus used to determine the actual bearing preload F_{actual} from the measured parameter value σ_{actual}, and is also used to determine a target value σ_{target} of the measured parameter corresponding to the desired preload F_{P}. The target value for the initial axial gap δ_{target} is then obtained by identifying the target shim as the shim from the plurality of shims that generates the target parameter value σ_{target} at the predetermined axial force F_{A}.

The analytical model may be constructed using finite element analysis of the bearing arrangement, which takes into account the geometry of the components of the bearing arrangement and preferably also interference between the components.

In one example, the bearing arrangement comprise a double-row taper roller bearing or a double row angular contact bearing, in which first and second bearing inner rings are mounted on a shaft and first and second bearing outer rings are mounted in a housing. The displaceable bearing ring may be a first inner ring or a first outer ring of the bearing arrangement. The arrangement further comprises a fixed abutment comprising an axial side face against which the shim is mounted in pressing contact.

The fixed abutment may be formed on the part to which the displaceable bearing ring is mounted. In one embodiment, the displaceable inner ring is the first inner ring of a double-row taper roller bearing. The fixed abutment may be formed by an axial side face on the shaft to which the bearing inner rings are mounted. Alternatively, the fixed abutment may be formed by an axial side face of the second inner ring.

When the first outer bearing ring is the displaceable bearing ring, the fixed abutment may be formed by an axial side face of the second outer ring or by an axial side face on the housing to which the bearing outer rings are mounted.

In another embodiment, the bearing arrangement comprises a double-row taper roller bearing and further comprises a flange element mounted between the locknut and the first inner ring. For each shim in the plurality of shims, the initial axial gap generated by each shim and the associated clamping force at which the shim makes contact with the displaceable inner ring is calculated. The calculation suitably takes into account an initial interference between the nut and the flange. Preferably, press-fit data is also taken into account.

In one example, the stiffness of the bearing arrangement is measured by applying an impulse in an axial direction to e.g. the shaft, which causes the bearing arrangement to vibrate. At an opposite end of the shaft, an accelerometer may be mounted that is connected to a processing unit that analyses the accelerometer signal and determines an axial mode eigenfrequency. The analytical model in this example is then configured to correlate measured eigenfrequency and bearing preload and applied axial force.

It is also possible to measure a bending mode eigenfrequency associated with the delivered impulse.

In a still further example, actual bearing preload is measured by measuring an axial displacement of an axial surface of the bearing arrangement relative to a fixed reference.

The method of the invention thus allows a variety of measurement techniques to be employed and enables a straightforward selection of a shim that will generate the desired preload in a particular bearing arrangement. These and other advantages of the present invention will become apparent from the following detailed description and accompanying drawings.

### DESCRIPTION OF THE FIGURES

In the following, the invention is described with reference to the accompanying drawings, in which:

FIG. 1a shows a partial cross-sectional view of a bearing arrangement which is being preloaded by applying an axial force and using a shim that sets a maximum amount of relative axial displacement between an inner and outer ring of the bearing arrangement;

FIG. 1b shows a partial cross-sectional view of the same bearing arrangement when the maximum relative axial displacement has occurred;

FIG. 2 shows a graph of a correlation between bearing preload and applied axial force for a plurality of different shims;

FIG. 3 shows an example of a test apparatus for measuring an actual preload of the bearing arrangement of FIGS. 1a and 1b; and

FIG. 4 shows a correlation between measured eigenfrequency, bearing preload and applied axial force for a plurality of different shims.

### DETAILED DESCRIPTION

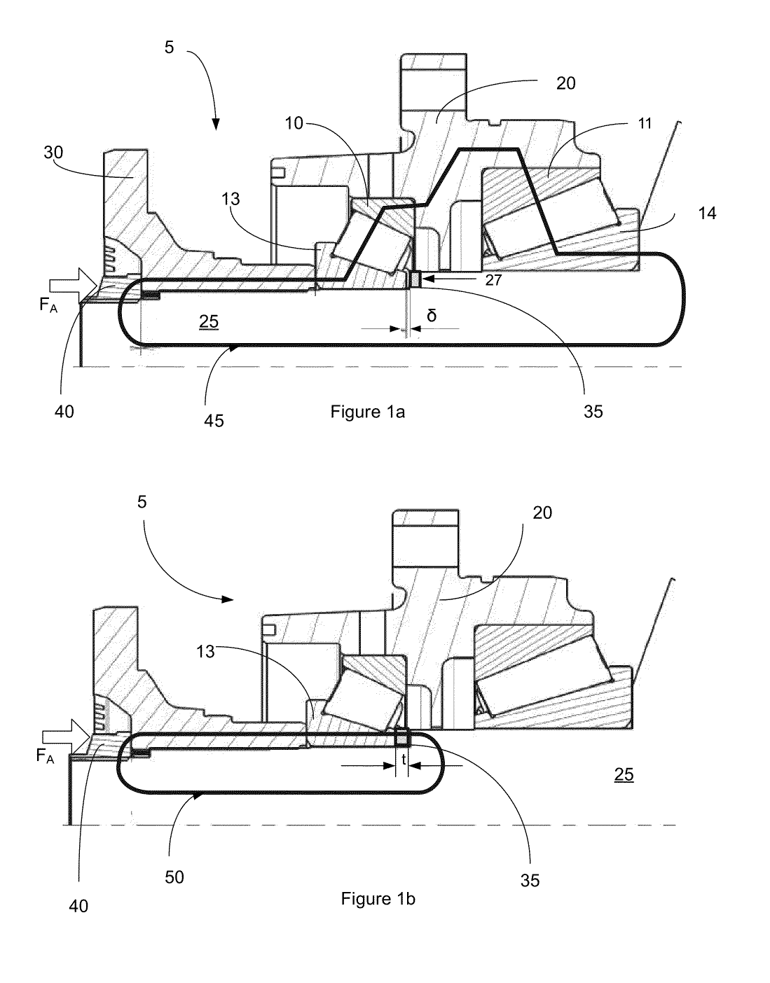

A bearing arrangement suitable for supporting a pinion shaft in a truck transmission is shown in FIGS. 1a and 1b. In use of the bearing arrangement, a certain preload is desired. The bearing arrangement comprises first and second taper roller bearings, which respectively have a first outer ring 10 and a second outer ring 11 mounted in a housing 20. A first inner ring 13 and a second inner ring 14 of the bearing are mounted on the pinion shaft 25. The arrangement further comprises a flange member 30 mounted on the shaft 25, in contact with an axial side face of the first inner ring 13. The flange 30 has splines for enabling driven rotation of the flange and the shaft. An opposite axial side face of the first inner ring faces an abutment 27 on the shaft, against which abutment a shim 35 is in contact. The bearing is preloaded by means of a locknut 40, which applies an axial force against the flange element 30 and against the first inner ring 13, causing an axial displacement of the first inner ring relative to the first outer ring 10.

Prior to preloading, an initial axial gap δ exists between the shim 35 and the first inner ring 13. The magnitude of the initial axial gap δ defines the maximum amount of relative axial displacement between the inner and outer bearing rings, which is predominantly responsible for setting bearing preload.

The locknut 40 is torqued to apply a predetermined axial force F_{A}. While the first inner ring 13 is not in contact with the shim 35 and the shaft abutment 27, the force applied by the locknut 40 follows a force circuit that flows from the first inner ring 13 to the shaft 25 via the first set of rollers, the first outer ring 10, the housing 20, the second outer ring 11, the second set of rollers and the second inner ring 14. This force circuit will be referred to as the preload force circuit, and is shown by the line indicated by reference numeral 45 in FIG. 1a.

As the axial force applied by the locknut increases, the first inner ring 13 is axially displaced towards the shim 35 until at a certain clamping force, the axial gap becomes zero, as shown in FIG. 1b. As mentioned, this relative axial displacement between the inner and outer rings is predominantly responsible for setting the preload of the bearing arrangement. The predetermined axial force F_{A} applied by the locknut is usually considerably higher than the clamping force at which the inner ring 13 makes contact with the shim 35, in order to securely lock the bearing arrangement such that it may withstand the application loads. After the clamping force has been reached, the majority of the excess axial force then follows a force circuit different from the preload force circuit 45. The excess axial force now predominantly flows from the first inner ring 13 to the shaft 27 through the shim 35. This force circuit 50, depicted in FIG. 1b, will be referred to as a clamping circuit.

For the depicted bearing arrangement, it has been found that approximately 10% of the excess axial force flows through the preload circuit, meaning that the magnitude of the predetermined axial nut force F_{A} influences bearing preload, even when a shim is used. In order to set a desired preload, it is therefore necessary to select a shim that will generate the desired preload at the predetermined axial nut force F_{A}.

The present invention defines a method of setting desired preload, based on selecting an appropriate shim.

The method of the invention makes use of an analytical model that correlates applied axial nut force and resulting bearing preload for a plurality of shims. Each shim is defined in terms of the clamping force F_{C} that “closes” the clamping circuit. Furthermore, for each clamping force, the associated initial axial gap δ between the shim and the bearing ring is calculated. Suitably, a table of values is generated, such as shown in Table 1:

TABLE 1

| | Initial axial | Nut clamping |
|---|---|---|
| | gap δ | force F_{C} |
| Shim 1 | δ₁ | F_{C1} |
| Shim 2 | δ₂ | F_{C2} |
| Shim 3 | δ₃ | F_{C3} |
| Shim 4 | δ₄ | F_{C4} |
| Shim 5 | δ₅ | F_{C5} |
| Shim i | δᵢ | F_{Ci} |

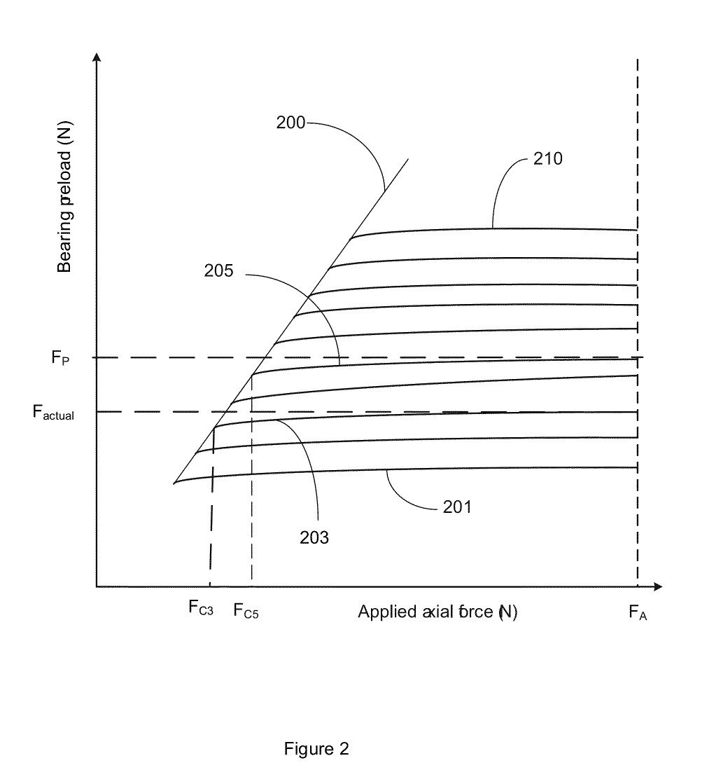

In the depicted arrangement, an initial interference between the locknut 40 and the flange element 30 is one of the factors that is taken into account in calculating the clamping force F_{C} and initial axial gap δ, along with bearing geometry and, preferably, press-fit data. The analytical model correlates bearing preload and applied axial force for each shim, enabling a library of bearing preload curves for different shims to be generated, such as shown in the graph of FIG. 2.

Bearing preload (y axis) is plotted against the axial force applied by the locknut 40 (x axis). The linear curve 200 shows the relationship between bearing preload and axial force when no shim is present, i.e. when all of the axial force flows through the preload circuit 45. The curves 201-210 respectively show the relationship between bearing preload and axial force for a first shim, a second shim, a third shim, a fourth shim, a fifth shim, a sixth shim, a seventh shim, an eighth shim a ninth shim and a 10^{th} shim. Only some of the curves have been numbered so as not to obscure the drawing.

Let assume that the desired preload to be set in the depicted bearing arrangement is F_{P} and that the locknut 40 applies a predetermined axial force F_{A}. It can be seen from curve 205 for the fifth shim that this shim generates the desired preload F_{P} at the predetermined nut force F_{A}. The fifth shim clamps at a clamping force F_{c5}. Let us assume that the initial axial gap δ₅ that corresponds to the clamping force F_{c5} is 34 microns. Thus, a shim that generates an initial axial gap of 34 microns needs to be selected in order to set the desired preload F_{P}. It is not possible, however, to know which value of initial axial gap a real shim generates.

The method of the invention therefore comprises a step of mounting a reference shim having a thickness t. Returning to FIGS. 1a and 1b, the shim 35 can be considered as the reference shim. As described previously, the bearing arrangement is preloaded by applying the predetermined axial nut force F_{A}. The actual initial axial gap δ associated with the reference shim is then determined. This determination comprises measuring the actual preload F_{actual} of the bearing arrangement, which will be described in more detail below. Returning to FIG. 2, it can be seen from the third curve 203 that the third shim generates the measured preload F_{actual} at the applied nut force F_{A}. The third shim closes the clamping circuit at a clamping force F_{c3}. Let us assume that the initial axial gap δ₃ associated with the clamping force F_{c3} is 28 microns.

Therefore, the difference between the actual initial axial gap and the desired initial axial gap is 28−34 microns=−6 microns. Consequently, the desired bearing preload can be set by replacing the reference shim 35 of thickness t with a shim that has a thickness of t−6 microns.

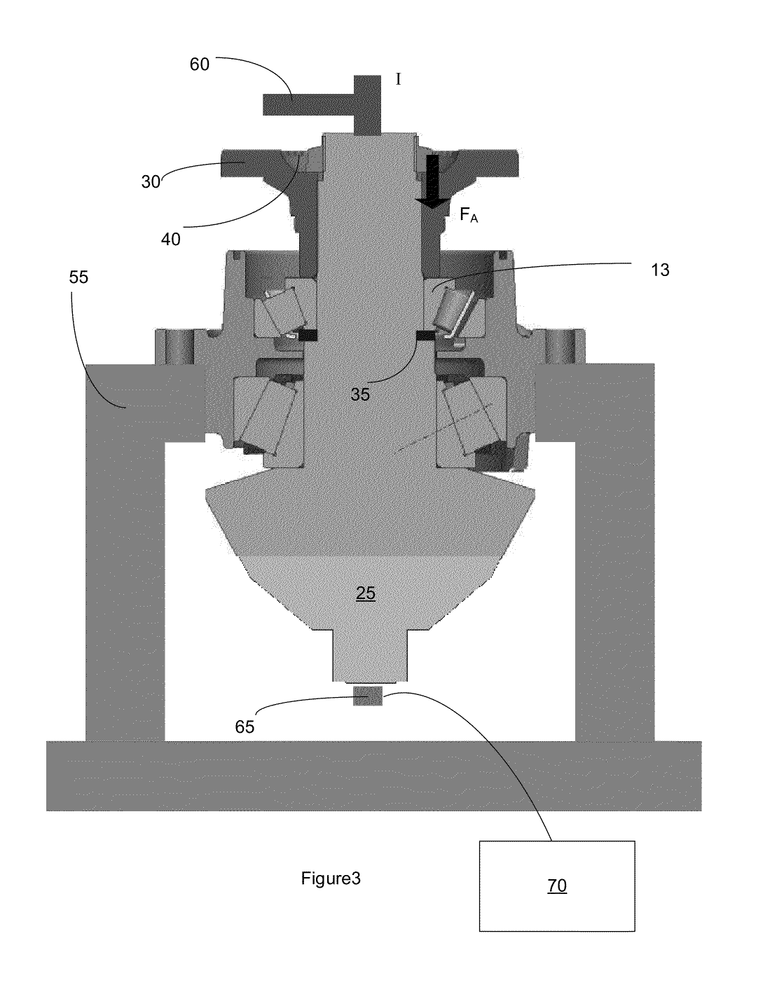

In a preferred embodiment of the method, the step of measuring bearing preload comprises measuring a parameter that is representative of the stiffness of the bearing arrangement. An example of a suitable measurement apparatus is shown in FIG. 3.

The bearing arrangement of FIGS. 1a and 1b is mounted on a test stand 55. A torque is applied to the locknut 40, which in turn applies a predetermined axial force F_{A} which is greater than a clamping force needed to close the initial axial gap between the reference shim 35 and the first inner ring 13.

Next, an impulse I that causes the bearing arrangement to vibrate is applied. In the depicted apparatus, an impact device 60 delivers an impulse I in axial direction to the shaft. The device is sensorized and the magnitude of the impulse is recorded.

The bearing arrangement is a system comprising bodies of different stiffness whose values determine the eigenfrequencies and mode shapes of the system as whole. The magnitude of the axial force applied to the system mainly affects the stiffness of the bearings through where the preload force is transmitted. It is therefore possible to determine a correlation between applied axial force, the preload force and the measured eigenfrequencies.

In the depicted apparatus, the axial mode eigenfrequencies are measured by an accelerometer 65 mounted at an opposite axial end of the shaft 25 from where the impulse is applied. It is also possible to measure the bending mode eigenfrequencies using an accelerometer mounted on the shaft circumference.

The measurement apparatus further comprises an analysis unit 70 which receives a frequency signal from the accelerometer 65 and an impulse signal from the sensor (not shown) on the impact device 60. The analysis unit 70 analyses these signals, to determine the eigenfrequencies, and is programmed with an analytical model that correlates eigenfrequency and bearing preload. The analytical model further comprises a correlation between eigenfrequency and applied axial force for a plurality of different shims.

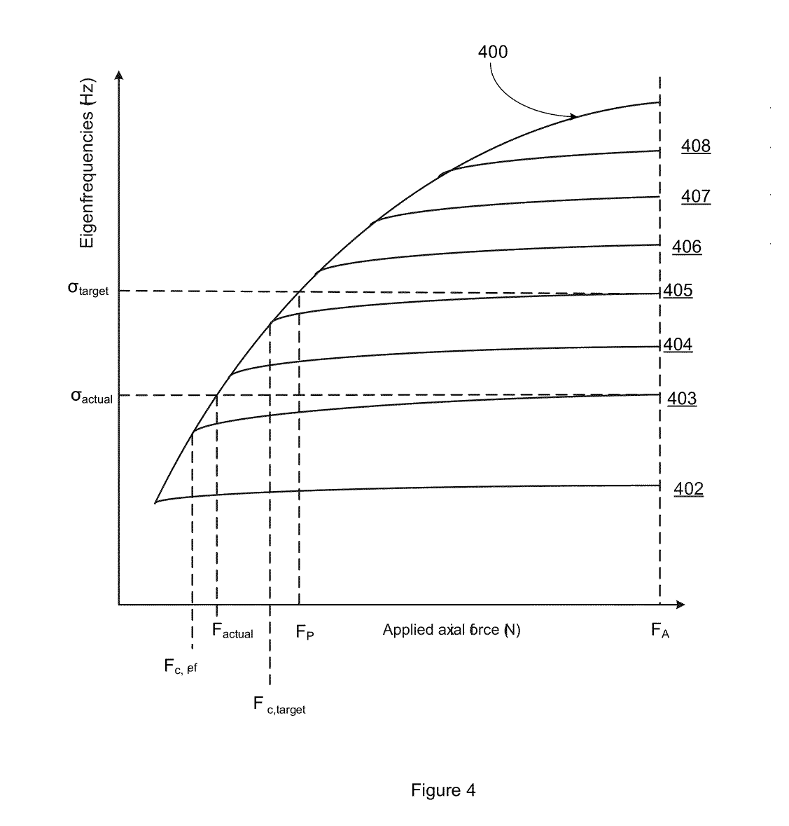

An example of an analytical model is represented by graph of FIG. 4 in which eigenfrequency along the y-axis is plotted against applied axial force along the x-axis. The first curve 400 represents the preload force curve, which directly correlates eigenfrequency to bearing preload. The second 402, third 403, fourth 404, fifth 405, sixth 406, seventh 407 and eighth curve 408 show the eigenfrequencies generated when different shims are present and are subjected to increasing axial force. As explained above, the shims are defined in terms of the initial axial gap and the clamping force at which the axial gap between the first bearing inner ring 13 and the shim 35 becomes zero.

Let us assume that the accelerometer measures an axial eigenfrequency of σ_{actual} Hz. The actual bearing preload is obtained from the preload force curve 400 and corresponds to a magnitude F_{actual}. The measured eigenfrequency corresponds to a unique value of bearing preload, regardless of which shim has been used. For setting a desired preload, however, it is necessary to identify which shim from the library of shims has, in fact, been used. As explained previously, the known axial force applied by the locknut F_{A}, in combination with the actual measured quantity, is used for the identification. From FIG. 4, we can see that at the applied axial force F_{A}, a shim which is defined by the third curve 403 will generate the measured eigenfrequency σ_{actual}.

The method for selecting an appropriate shim for setting a desired preload F_{P} is then identical to the method described above.

The reference shim is a shim which closes the clamping circuit at a clamping force F_{c, ref}. Let us assume that this clamping force is associated with an initial axial gap δ_{f}. At the desired preload F_{P}, the associated eigenfrequency is σ_{target}, which is the eigenfrequency generated when a target shim defined by the fifth curve 405 is subjected to the predetermined axial nut force F_{A}. The target shim closes the clamping circuit at a clamping force F_{c, target}. Let us assume that this clamping force is associated with an initial axial gap δ_{target}. The desired bearing preload can therefore be set by replacing the reference shim 35 with a shim that has a thickness of t+(δ_{actual}−δ_{target}).

A number of aspects/embodiments of the invention have been described. It is to be understood that each aspect/embodiment may be combined with any other aspect/embodiment. Moreover the invention is not restricted to the described embodiments, but may be varied within the scope of the accompanying patent claims.

1. A method of setting a desired axial preload F_{P} in a bearing arrangement comprising an inner ring and an outer ring, whereby one of the bearing rings is axially displaceable relative to the other of the bearing rings, the method comprising steps of:
(a) mounting a reference shim, having a thickness t, between the axially displaceable bearing ring and a fixed abutment, and preloading the bearing arrangement by applying a predetermined axial force F_{A} against the displaceable bearing ring, whereby
prior to preloading, there is an initial axial gap δ_{ref} between the reference shim and the displaceable bearing ring, and at a reference clamping force F_{c, ref}, less than the predetermined axial force F_{A,} the displaceable bearing ring makes contact with the reference shim;
(b) measuring an actual preload F_{actual} of the bearing arrangement;
(c) constructing an analytical model that correlates bearing preload to applied axial force on the bearing arrangement, the model encompassing a plurality of shims that define different values of the initial axial gap δ₁, δ₂, δ₃, . . . δᵢ between the shim in question and the displaceable bearing ring and corresponding values for the clamping force F_{c1}, F_{c2}, F_{c3}, . . . F_{ci} at which the shim makes contact with the displaceable bearing ring;
(d) using the analytical model to:
determine the value of the initial axial gap δ_{ref} and the corresponding reference clamping force F_{C, ref}, by identifying the reference shim as the shim from the plurality of shims which generates the measured preload F_{actual} at the predetermined axial force F_{A}; and
determine a target value of the initial axial gap δ_{target} and a corresponding target clamping force F_{c, target}, by identifying a target shim as a shim from the plurality of shims that generates the desired preload F_{P} at the predetermined axial force F_{A}; and
(e) replacing the reference shim of thickness t with a second shim having a thickness of t+(δ_{ref}−δ_{target}), such that the desired preload F_{P} is achieved when the predetermined axial force F_{A} is applied to the bearing arrangement.

2. The method of claim 1, wherein:
step (b) of measuring actual bearing preload F_{actual} comprises measuring a value σ_{actual} of a parameter that is representative of the stiffness of the bearing arrangement;
the analytical model of step (c) defines a correlation between the measured parameter and bearing preload and further defines a correlation between the measured parameter and applied axial force for the plurality of shims; and
in step (d) the analytical model is used to:
determine actual bearing preload from the measured parameter value σ_{actual},
determine a target value σ_{target} of the measured parameter corresponding to the desired preload F_{P}; and
determine the target value for the initial axial gap δ_{target}, by identifying the target shim as the shim from the plurality of shims that generates the target parameter value σ_{target} at the predetermined axial force F_{A}.

3. The method of claim 2, wherein the step of measuring comprises causing the bearing arrangement to vibrate and the measured parameter is a resonant frequency.

4. The method of claim 3, wherein the measured parameter is an axial mode eigenfrequency.

5. The method of claim 3, wherein the measured parameter is a bending mode eigenfrequency.

6. The method of claim 1, wherein the bearing arrangement comprises a clamping element such as a locknut for applying the predetermined axial force F_{A}.

7. The method of claim 6, wherein the bearing arrangement further comprises a flange element mounted between the clamping element and the displaceable bearing ring.

8. The method of claim 1, wherein the bearing arrangement comprises a double-row taper rolling bearing or a double-row angular contact bearing, having first and second inner rings and first and second outer rings.

9. The method of claim 1, wherein the fixed abutment is an axial side face on a part to which the displaceable bearing ring is mounted.

10. The method of claim 8, wherein the displaceable bearing ring is the first inner ring and the fixed abutment is formed by an axial side face of the second inner ring.

11. The method of claim 8, wherein the displaceable bearing ring is the first outer ring and the fixed abutment is formed by an axial side face of the second outer ring.

12. The method of claim 7, wherein the step of constructing an analytical model is based on finite element analysis of the bearing arrangement.

13. The method of claim 12, wherein the initial axial gap δ₁, δ₂, δ₃, . . . δᵢ associated with the clamping force F_{c1}, F_{c2}, F_{c3}, . . . F_{ci} at which a shim from the plurality of shims comes into contact with the displaceable bearing ring is calculated, taking into account an interference between the clamping element and the flange.

14. The method of claim wherein the step of constructing an analytical model is based on finite element analysis of the bearing arrangement.
